(19) United States
(12) Patent Application Publication
(10) Pub. No.: US 2021/0182674 A1
(43) Pub. Date: Jun. 17, 2021

(54) AUTOMATIC TRAINING AND DEPLOYMENT OF DEEP LEARNING TECHNOLOGIES

(71) Applicant: Siemens Healthcare GmbH, Erlangen (DE)

(72) Inventors: Axel Avedis Petit, Plainsboro Township, NJ (US); Guillaume Chabin, Paris (FR); Eli Gibson, Plainsboro, NJ (US); Sasa Grbic, Plainsboro, NJ (US); Dorin Comaniciu, Princeton Junction, NJ (US)

(21) Appl. No.: 17/118,817

(22) Filed: Dec. 11, 2020

Related U.S. Application Data
(60) Provisional application No. 62/947,248, filed on Dec. 12, 2019.

(51) Int. Cl. G06N 3/08; G06K 9/62; G06F 8/60

(52) U.S. Cl. CPC G06N 3/08; G06F 8/60; G06K 9/6202; G06K 9/6262

(57) ABSTRACT

Systems and methods for automatically training a machine learning based model are provided. A trigger for automatically training a machine learning based model is received. In response to receiving the trigger, a preprocessing manager for executing preprocessing code for preprocessing training data is automatically invoked. A training manager for executing training code for training the machine learning based model based on the preprocessed training data is automatically invoked. A deployment manager for executing deployment code for converting the trained machine learning based model to a production model is automatically invoked. The production model is output.

### CROSS-REFERENCE TO RELATED APPLICATIONS

This application claims the benefit of U.S. Provisional Application No. 62/947,248, filed Dec. 12, 2019, the disclosure of which is incorporated herein by reference in its entirety.

### TECHNICAL FIELD

The present invention relates generally to deep learning technologies, and in particular to automatic training and deployment of deep learning technologies to improve model performance.

### BACKGROUND

Deep learning models have been utilized for performing various medical imaging analysis tasks, such as, e.g., cancer detection and organ segmentation. Such deep learning models are trained with a large amount of training data collected from different clinical locations, fulfillment centers, and other sources. Conventionally, the training workflow for training deep learning models is manually performed by a scientist. However, the manual training of deep learning models is time consuming, taking away time from the scientist that can otherwise be used for performing clinical research and other important tasks. Additionally, the manual training of deep learning models makes it difficult to regularly retrain the deep learning models with new training data which would improve model performance.

### BRIEF SUMMARY OF THE INVENTION

In accordance with one or more embodiments, systems and methods for automatically training a machine learning based model are provided. A trigger for automatically training a machine learning based model is received. In response to receiving the trigger, a preprocessing manager for executing preprocessing code for preprocessing training data is automatically invoked. A training manager for executing training code for training the machine learning based model based on the preprocessed training data is automatically invoked. A deployment manager for executing deployment code for converting the trained machine learning based model to a production model is automatically invoked. The production model is output. In one embodiment, the machine learning based model is a deep learning model.

In one embodiment, the trigger for automatically training a machine learning based model is received in response to a user request or at a predetermined time.

In one embodiment, the steps of receiving, automatically invoking the preprocessing manager, automatically invoking the training manager, and automatically invoking the deployment manager are performed by a main manager. The main manager, the preprocessing manager, the training manager, and the deployment manager are implemented in separate nodes of a computing device.

In one embodiment, the preprocessing code is further for generating a preprocessing report comprising database descriptors and statistics for the training data and validation data, the training code is further for generating a training report comprising a log of training data, and the deployment code is further for generating a conversion report comprising data comparing performance of the trained machine learning based model and the production model and a performance report comprising an evaluation of the performance of the production model.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative system architecture for automatically training a machine learning based model, in accordance with one or more embodiments;

FIG. 2 shows a workflow for automatically training a machine learning based model, in accordance with one or more embodiments;

FIG. 3 shows a method for automatically training a machine learning based model, in accordance with one or more embodiments;

FIG. 4 shows an exemplary artificial neural network that may be used to implement one or more embodiments;

FIG. 5 shows a convolutional neural network that may be used to implement one or more embodiments; and

FIG. 6 shows a high-level block diagram of a computer that may be used to implement one or more embodiments.

### DETAILED DESCRIPTION

The present invention generally relates to methods and systems for automatic training and deployment of deep learning technologies. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system. Embodiments described herein are described with reference to the drawings, where like reference numerals represent the same or similar elements.

Embodiments described herein provide for methods and systems for automating the training workflow of deep learning models and other machine learning based models. To facilitate the automatic training of deep learning networks, the training workflow is decomposed into three stages: preprocessing, training, and deployment. Accordingly, a main manager is configured to orchestrate the automatic invocation of a preprocessing manager for preprocessing training data, a training manager for training deep learning models based on the preprocessed training data, and a deployment manager for converting the trained deep learning model into a production model for use in a clinical site. Advantageously, by automating the training workflow, embodiments described herein enable scientists to allocate their time for performing clinical research projects and other important tasks instead of manually managing the training workflow for deep learning models. In addition, embodiments described herein enable automatic training or retraining of deep learning models at periodic intervals using newly available training data to thereby improve model performance.

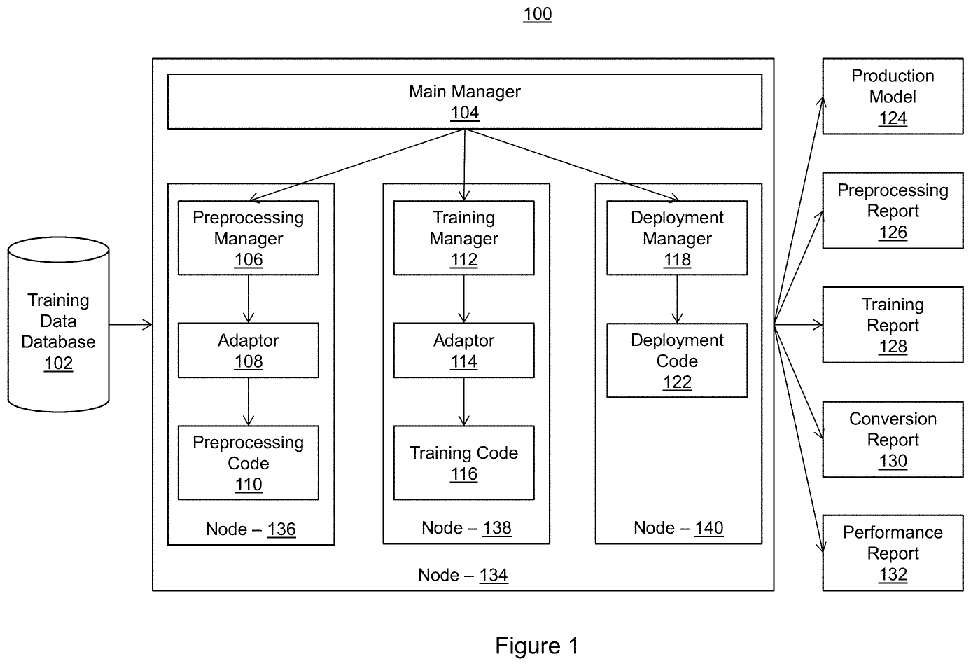

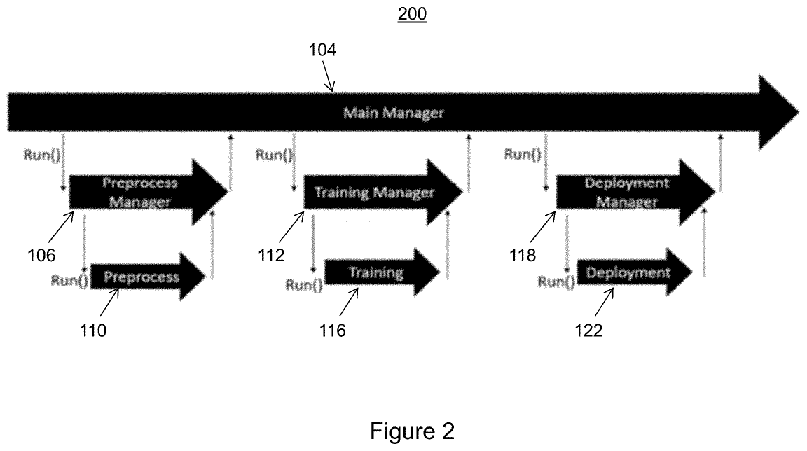

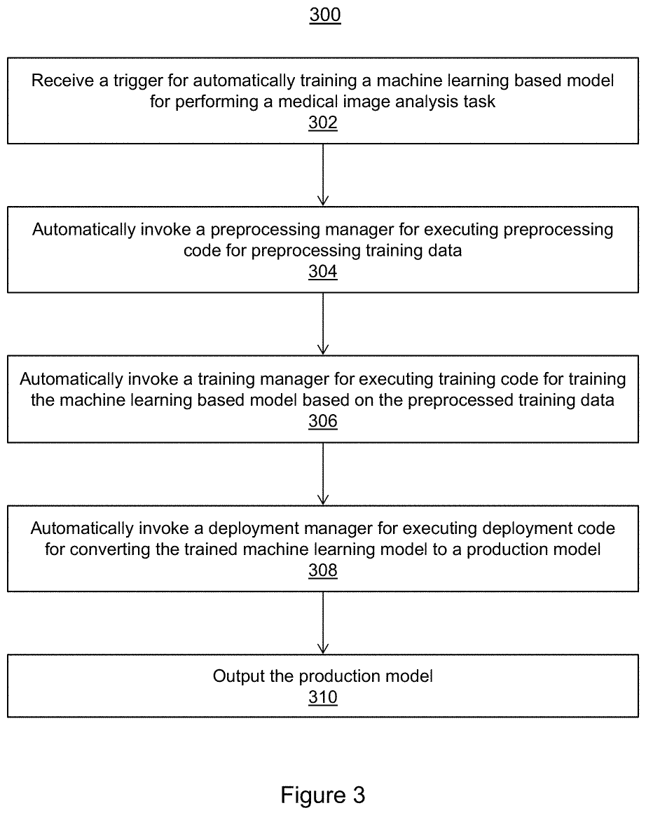

FIG. 1 shows an illustrative system architecture 100 for automatically training a machine learning based model, in accordance with one or more embodiments. As shown in system architecture 100, a main manager 104 is configured to orchestrate the automatic invocation of a preprocessing manager 106, a training manager 112, and a deployment manager 118 for automatic training of machine learning based models. Main manager 104, preprocessing manager 106, training manager 112, and deployment manager 118 are respectively implemented by nodes 134, 136, 138, and 140. Each node 134, 136, 138, and 140 may have different specifications to meet performance requirements of each manager. In one embodiment, nodes 134, 136, 138, and 140 are CPU (central processing unit) or GPU (graphics processing unit) nodes of a supercomputer. In one embodiment, nodes 134, 136, 138, and 140 (and other resources) may be allocated in accordance with a configuration file written by a user (e.g., scientist) to respectively implement main manager 104, preprocessing manager 106, training manager 112, and deployment manager 118. FIG. 1 will be further described below in connection with FIGS. 2 and 3.

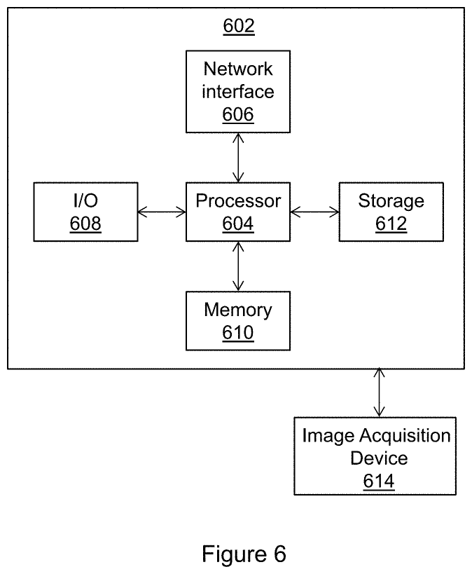

FIG. 2 shows a workflow 200 for automatically training a machine learning based model, in accordance with one or more embodiments. In one example, various elements of workflow 200 are implemented by one or more suitable computing devices (e.g., a supercomputer) in accordance with system architecture 100 of FIG. 1. FIG. 3 shows a method 300 for automatically training a machine learning based model, in accordance with one or more embodiments. FIG. 2 and FIG. 3 will be discussed together, with continued reference to FIG. 1. The steps of method 300 of FIG. 3 may be performed by one or more suitable computing devices, such as, e.g., computer 602 of FIG. 6. In one embodiment, the steps of method 300 are performed by main manager 104 of FIGS. 1 and 2.

At step 302, a trigger for automatically training a machine learning based model is received. The machine learning based model may be a deep learning model or any suitable machine learning based model for performing a medical image analysis task, such as, e.g., detection, segmentation, etc. The trigger may be any suitable trigger for training the machine learning based model. In one embodiment, the trigger is received in response to a user request. In another embodiment, the trigger is received at predefined times or at predefined time intervals. In another embodiment, the trigger is received in response to a certain event, such as, e.g., the collection of a particular amount of new training data.

At step 304, in response to receiving the trigger, a preprocessing manager for executing preprocessing code for preprocessing training data is automatically invoked. In one example, the preprocessing manager may be preprocessing manager 106 of FIGS. 1 and 2. As shown in FIGS. 1 and 2, preprocessing manager 106 runs or executes preprocessing code 110 via adaptor 108. Adaptor 108 is an interface between preprocessing manager 106 and preprocessing code 110. Preprocessing code 110 comprises computer program instructions written by a user (e.g., a scientist) defining how training data is to be preprocessed. For example, preprocessing code 110 may comprise computer program instructions for augmenting training data (e.g., by artificially enriching the dataset with images derived from the images), formatting the training data into a particular training format used at training (e.g., by cropping and resampling the training data to a particular resolution and saving the images into a specific format that may differ from the one used in the training data database), splitting the training data into training/validation datasets, moving the training data to dedicated locations required by training, and generating renderings for review.

Preprocessing code 110 is also configured to generate a preprocessing report 126 comprising database keys (e.g., identifiers) for the training data. Database keys are key information on the data used for training and preprocess, such as, e.g., the data keys in the training and validations splits or other descriptors that reflect the distribution of the data used. Preprocessing report 126 may comprise any statistics representing the data distribution of the training and validation dataset, any statistic derived from image metadata representing the image acquisition parameters, the image content, demographics, run time, image renderings, etc.

The training data comprises training images and corresponding annotations stored in training data database 102. The training images may be of any suitable modality, such as, e.g., MRI (magnetic resonance imaging), CT (computed tomography), x-ray, US (ultrasound), or any other modality or combination of modalities. The training images may comprise 2D (two dimensional) images or 3D (three dimensional) volumes, and may each comprise a single image or a plurality of images (e.g., a sequence of images acquired over time). The training images may be received directly from an image acquisition device as the images are acquired and stored in training data database 102, or can be received by loading previously acquired images from a storage or memory of a computer system or receiving the images from a remote computer system and stored in training data database 102.

Once executed, preprocessing code 110 outputs the path to the preprocessed training data and preprocessing report 126. Preprocessing manager 106 then returns an indication that the preprocessing of the training data has been completed to main manager 104.

At step 306, a training manager for executing training code for training the machine learning based model based on the preprocessed training data is automatically invoked. The training manager may be automatically invoked in response to receiving the indication, from preprocessing manager 106, that the preprocessing of the training data has been completed. In one example, the training manager may be training manager 112 of FIGS. 1 and 2. As shown in FIGS. 1 and 2, training manager 112 runs or executes training code 116 via adaptor 114. Adaptor 114 is an interface between training manager 112 and training code 116. Training code 116 comprises computer program instructions written by a user defining how the machine learning based model is to be trained. For example, training code 116 may comprise computer program instructions for defining the machine learning based model, weights and annotations, optimization functions, for saving intermediate models, etc. Training code 116 is also configured to generate a training report 128 comprising a log of training data, such as, e.g., accuracy, validation loss, training and validation curves (loss and other key performance indicators), performance at each epoch, run time per epoch and total run time, network visualizations, etc.

Once executed, training code 116 outputs the path to the trained machine learning based model and training report 128. Training manager 112 then returns an indication that the training of the machine learning based model has been completed and the path to the trained machine learning based model to main manager 104.

At step 308, a deployment manger for executing code for converting the trained machine learning based model to a production model is automatically invoked. The deployment manager may be automatically invoked in response to receiving the indication, from training manager 112, that the training of the machine learning based model has been completed. In one example, the deployment manager may be deployment manager 118 of FIGS. 1 and 2. As shown in FIGS. 1 and 2, deployment manager 118 runs or executes deployment code 122. Deployment code 122 comprises computer program instructions written by a user defining how the trained machine learning model is to be converted to production model 124. The trained machine learning based model is implemented with a framework or format suitable for training and development, but may not be suitable for a production environment. One example of a production environment is a clinical site where machine learning based models must be applied with speed, accuracy, and reliability. Deployment code 122 converts the trained machine learning based model to production model 124 implemented with a framework or format suitable for a production environment. Deployment code 122 is dependent on the training framework and the target production framework. In one embodiment, production model 124 is implemented with a framework or format optimized for the production environment, such that production model 124 is faster, more reliable, etc. as compared to the trained machine learning based model. Deployment code 122 is also configured to generate a conversion report 130 and a performance report 132. Conversion report 130 comprises data comparing the performance of the trained machine learning based model and the production model. For example, conversion report 130 may comprise comparisons on random images and real images to make sure inferences on both networks are producing the same results, and gains in key performance indicators for the production model 124 (e.g., run time, memory requirements, model size, etc.). Performance report 132 comprises an evaluation of the performance of the production model (e.g., based on user defined metrics). For example, performance report 132 may compute the performance of production model 124 on a validation set, compare predictions with ground truth data and baseline versions, and generate renderings for predictions on the validation data set.

Once executed, deployment code 122 outputs paths to production model 124 along with conversion report 130 and performance report 132. Deployment manager 118 then returns an indication that the conversion of the trained machine learning based model to production model 124 has been completed and a path to production model 124 to main manager 104.

At step 310, production model 124 is output. In some embodiments, preprocessing report 126, training report 128, conversion report 130, and/or performance report 132 are also output. Production model 124, preprocessing report 126, training report 128, conversion report 130, and/or performance report 132 may be output in response to receiving the indication, from deployment manager 112, that the conversion of the trained machine learning based model to the production model has been completed. Production model 124, preprocessing report 126, training report 128, conversion report 130, and/or performance report 132 may be output by storing production model 124, preprocessing report 126, training report 128, conversion report 130, and/or performance report 132 on a memory or storage of a computer system, or by transmitting production model 124, preprocessing report 126, training report 128, conversion report 130, and/or performance report 132 to a remote computer system. In some embodiments, the preprocessing report 126, training report 128, conversion report 130, and/or performance report 132 may be output by displaying preprocessing report 126, training report 128, conversion report 130, and/or performance report 132 on a display device of a computer system.

Advantageously, the automatic training of machine learning based models in accordance with method 300 enables frequent training and retraining of machine learning based models for performing medical imaging analysis tasks, thereby improving model performance. By decomposing the training workflow for training machine learning based models into a preprocessing stage, a training stage, and a deployment stage, the system architecture (e.g., system architecture 100 of FIG. 1) implementing method 300 may be modularly defined, enabling a user to easily input their code (e.g., preprocessing code 110, training code 116, and/or deployment code 122) to implement automatic training of machine learning based models in accordance with method 300. Further, the decomposition of the training workflow enables a report to be automatically generated for each step, allowing the user to better understand the entire training workflow from training data collection to generation of the production model. Such reports may additionally be utilized for submission to regulatory agencies.

Embodiments described herein are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the providing system.

In general, a trained machine learning based network mimics cognitive functions that humans associate with other human minds. In particular, by training based on training data, the trained machine learning based network is able to adapt to new circumstances and to detect and extrapolate patterns.

In general, parameters of a machine learning based network can be adapted by means of training. In particular, supervised training, semi-supervised training, unsupervised training, reinforcement learning and/or active learning can be used. Furthermore, representation learning (an alternative term is “feature learning”) can be used. In particular, the parameters of the trained machine learning based network can be adapted iteratively by several steps of training.

In particular, a trained machine learning based network can comprise a neural network, a support vector machine, a decision tree, and/or a Bayesian network, and/or the trained machine learning based network can be based on k-means clustering, Q-learning, genetic algorithms, and/or association rules. In particular, a neural network can be a deep neural network, a convolutional neural network, or a convolutional deep neural network. Furthermore, a neural network can be an adversarial network, a deep adversarial network and/or a generative adversarial network.

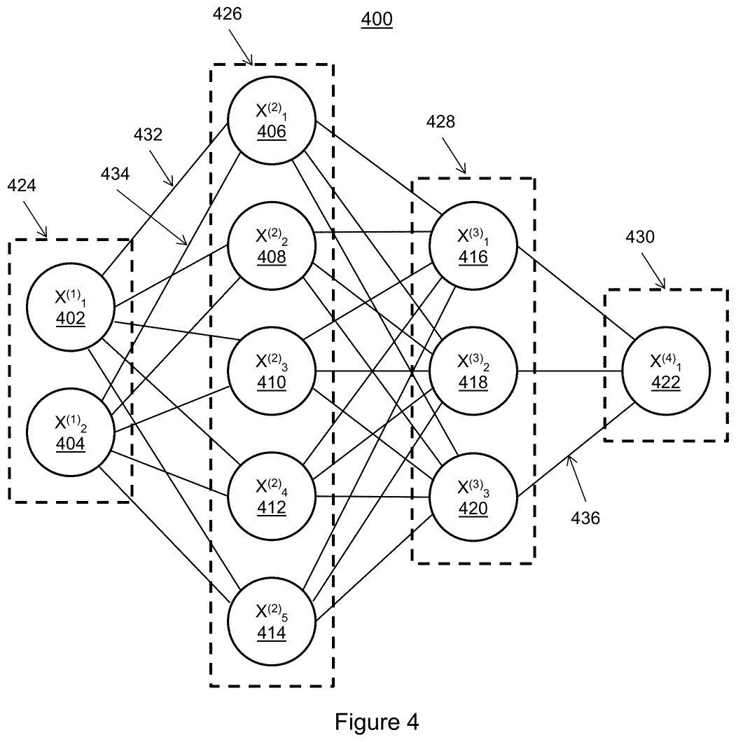

FIG. 4 shows an embodiment of an artificial neural network 400, in accordance with one or more embodiments. Alternative terms for “artificial neural network” are “neural network”, “artificial neural net” or “neural net”. Machine learning networks described herein, such as, e.g., the machine learning based model automatically trained according to workflow 200 of FIG. 2 or method 300 of FIG. 3, may be implemented using artificial neural network 400.

The artificial neural network 400 comprises nodes 402-422 and edges 432, 434, . . . , 436, wherein each edge 432, 434, . . . , 436 is a directed connection from a first node 402-422 to a second node 402-422. In general, the first node 402-422 and the second node 402-422 are different nodes 402-422, it is also possible that the first node 402-422 and the second node 402-422 are identical. For example, in FIG. 4, the edge 432 is a directed connection from the node 402 to the node 406, and the edge 434 is a directed connection from the node 404 to the node 406. An edge 432, 434, . . . , 436 from a first node 402-422 to a second node 402-422 is also denoted as “ingoing edge” for the second node 402-422 and as “outgoing edge” for the first node 402-422.

In this embodiment, the nodes 402-422 of the artificial neural network 400 can be arranged in layers 424-430, wherein the layers can comprise an intrinsic order introduced by the edges 432, 434, . . . , 436 between the nodes 402-422. In particular, edges 432, 434, . . . , 436 can exist only between neighboring layers of nodes. In the embodiment shown in FIG. 4, there is an input layer 424 comprising only nodes 402 and 404 without an incoming edge, an output layer 430 comprising only node 422 without outgoing edges, and hidden layers 426, 428 in-between the input layer 424 and the output layer 430. In general, the number of hidden layers 426, 428 can be chosen arbitrarily. The number of nodes 402 and 404 within the input layer 424 usually relates to the number of input values of the neural network 400, and the number of nodes 422 within the output layer 430 usually relates to the number of output values of the neural network 400.

In particular, a (real) number can be assigned as a value to every node 402-422 of the neural network 400. Here, x⁽ⁿ⁾ᵢ denotes the value of the i-th node 402-422 of the n-th layer 424-430. The values of the nodes 402-422 of the input layer 424 are equivalent to the input values of the neural network 400, the value of the node 422 of the output layer 430 is equivalent to the output value of the neural network 400. Furthermore, each edge 432, 434, . . . , 436 can comprise a weight being a real number, in particular, the weight is a real number within the interval [−1, 1] or within the interval [0, 1]. Here, w^{(m,n)}_{i,j} denotes the weight of the edge between the i-th node 402-422 of the m-th layer 424-430 and the j-th node 402-422 of the n-th layer 424-430. Furthermore, the abbreviation w⁽ⁿ⁾_{i,j} is defined for the weight w^{(n,n+1)}_{i,j}.

In particular, to calculate the output values of the neural network 400, the input values are propagated through the neural network. In particular, the values of the nodes 402-422 of the (n+1)-th layer 424-430 can be calculated based on the values of the nodes 402-422 of the n-th layer 424-430 by

xⱼ⁽ⁿ⁺¹⁾f(Σᵢxᵢ⁽ⁿ⁾·w_{i,j}⁽ⁿ⁾).

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions The transfer function is mainly used for normalization purposes.

In particular, the values are propagated layer-wise through the neural network, wherein values of the input layer 424 are given by the input of the neural network 400, wherein values of the first hidden layer 426 can be calculated based on the values of the input layer 424 of the neural network, wherein values of the second hidden layer 428 can be calculated based in the values of the first hidden layer 426, etc.

In order to set the values w^{(m,n)}_{i,j} for the edges, the neural network 400 has to be trained using training data. In particular, training data comprises training input data and training output data (denoted as tᵢ). For a training step, the neural network 400 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 400 (backpropagation algorithm). In particular, the weights are changed according to

w′_{i,j}⁽ⁿ⁾=w_{i,j}⁽ⁿ⁾·γ·δⱼ⁽ⁿ⁾·xᵢ⁽ⁿ⁾

wherein γ is a learning rate, and the numbers δ⁽ⁿ⁾ⱼ can be recursively calculated as

δⱼ⁽ⁿ⁾=(Σₖδₖ⁽ⁿ⁺¹⁾·w_{j,k}⁽ⁿ⁺¹⁾)·f′(Σᵢxᵢ⁽ⁿ⁾·w_{i,j}⁽ⁿ⁾)

based on δ⁽ⁿ⁺¹⁾ⱼ, if the (n+1)-th layer is not the output layer, and

δⱼ⁽ⁿ⁾=(xₖ⁽ⁿ⁺¹⁾−tⱼ⁽ⁿ⁺¹⁾)·f′(Σᵢxᵢ⁽ⁿ⁾·w_{i,j}⁽ⁿ⁾)

if the (n+1)-th layer is the output layer 430, wherein f′ is the first derivative of the activation function, and y⁽ⁿ⁺¹⁾ⱼ is the comparison training value for the j-th node of the output layer 430.

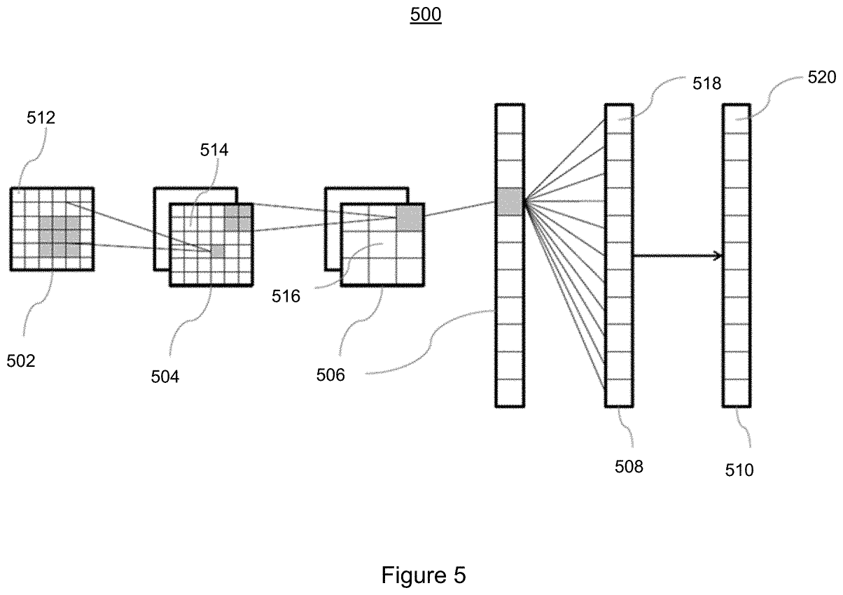

FIG. 5 shows a convolutional neural network 500, in accordance with one or more embodiments. Machine learning networks described herein, such as, e.g., the machine learning based model automatically trained according to workflow 200 of FIG. 2 or method 300 of FIG. 3, may be implemented using convolutional neural network 500.

In the embodiment shown in FIG. 5, the convolutional neural network comprises 500 an input layer 502, a convolutional layer 504, a pooling layer 506, a fully connected layer 508, and an output layer 510. Alternatively, the convolutional neural network 500 can comprise several convolutional layers 504, several pooling layers 506, and several fully connected layers 508, as well as other types of layers. The order of the layers can be chosen arbitrarily, usually fully connected layers 508 are used as the last layers before the output layer 510.

In particular, within a convolutional neural network 500, the nodes 512-520 of one layer 502-510 can be considered to be arranged as a d-dimensional matrix or as a d-dimensional image. In particular, in the two-dimensional case the value of the node 512-520 indexed with i and j in the n-th layer 502-510 can be denoted as x⁽ⁿ_{)[i,j]}. However, the arrangement of the nodes 512-520 of one layer 502-510 does not have an effect on the calculations executed within the convolutional neural network 500 as such, since these are given solely by the structure and the weights of the edges.

In particular, a convolutional layer 504 is characterized by the structure and the weights of the incoming edges forming a convolution operation based on a certain number of kernels. In particular, the structure and the weights of the incoming edges are chosen such that the values x⁽ⁿ⁾ₖ of the nodes 514 of the convolutional layer 504 are calculated as a convolution x⁽ⁿ⁾ₖ=Kₖ*x⁽ⁿ⁻¹⁾ based on the values x⁽ⁿ⁻¹⁾ of the nodes 512 of the preceding layer 502, where the convolution*is defined in the two-dimensional case as

xₖ⁽ⁿ⁾[i,j]=(Kₖ*x⁽ⁿ⁻¹⁾) [i,j]=Σ_{i′}Σ_{j′}Kₖ[i′,j′]·x⁽ⁿ⁻¹⁾[i−i′, j−j′].

Here the k-th kernel Kₖ is a d-dimensional matrix (in this embodiment a two-dimensional matrix), which is usually small compared to the number of nodes 512-518 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 512-520 in the respective layer 502-510. In particular, for a convolutional layer 504, the number of nodes 514 in the convolutional layer is equivalent to the number of nodes 512 in the preceding layer 502 multiplied with the number of kernels.

If the nodes 512 of the preceding layer 502 are arranged as a d-dimensional matrix, using a plurality of kernels can be interpreted as adding a further dimension (denoted as “depth” dimension), so that the nodes 514 of the convolutional layer 504 are arranged as a (d+1)-dimensional matrix. If the nodes 512 of the preceding layer 502 are already arranged as a (d+1)-dimensional matrix comprising a depth dimension, using a plurality of kernels can be interpreted as expanding along the depth dimension, so that the nodes 514 of the convolutional layer 504 are arranged also as a (d+1)-dimensional matrix, wherein the size of the (d+1)-dimensional matrix with respect to the depth dimension is by a factor of the number of kernels larger than in the preceding layer 502.

The advantage of using convolutional layers 504 is that spatially local correlation of the input data can exploited by enforcing a local connectivity pattern between nodes of adjacent layers, in particular by each node being connected to only a small region of the nodes of the preceding layer.

In embodiment shown in FIG. 5, the input layer 502 comprises 36 nodes 512, arranged as a two-dimensional 6×6 matrix. The convolutional layer 504 comprises 72 nodes 514, arranged as two two-dimensional 6×6 matrices, each of the two matrices being the result of a convolution of the values of the input layer with a kernel. Equivalently, the nodes 514 of the convolutional layer 504 can be interpreted as arranges as a three-dimensional 6×6×2 matrix, wherein the last dimension is the depth dimension.

A pooling layer 506 can be characterized by the structure and the weights of the incoming edges and the activation function of its nodes 516 forming a pooling operation based on a non-linear pooling function f. For example, in the two dimensional case the values x⁽ⁿ⁾ of the nodes 516 of the pooling layer 506 can be calculated based on the values x⁽ⁿ⁻¹⁾ of the nodes 514 of the preceding layer 504 as

x⁽ⁿ⁾[i,j]=f(x⁽ⁿ⁻¹⁾[id₁, jd₂], . . . , x⁽ⁿ⁻¹⁾[id₁+d₁−1, jd₂+d₂−1])

In other words, by using a pooling layer 506, the number of nodes 514, 516 can be reduced, by replacing a number d1·d2 of neighboring nodes 514 in the preceding layer 504 with a single node 516 being calculated as a function of the values of said number of neighboring nodes in the pooling layer. In particular, the pooling function f can be the max-function, the average or the L2-Norm. In particular, for a pooling layer 506 the weights of the incoming edges are fixed and are not modified by training.

The advantage of using a pooling layer 506 is that the number of nodes 514, 516 and the number of parameters is reduced. This leads to the amount of computation in the network being reduced and to a control of overfitting.

In the embodiment shown in FIG. 5, the pooling layer 506 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 508 can be characterized by the fact that a majority, in particular, all edges between nodes 516 of the previous layer 506 and the nodes 518 of the fully-connected layer 508 are present, and wherein the weight of each of the edges can be adjusted individually.

In this embodiment, the nodes 516 of the preceding layer 506 of the fully-connected layer 508 are displayed both as two-dimensional matrices, and additionally as non-related nodes (indicated as a line of nodes, wherein the number of nodes was reduced for a better presentability). In this embodiment, the number of nodes 518 in the fully connected layer 508 is equal to the number of nodes 516 in the preceding layer 506. Alternatively, the number of nodes 516, 518 can differ.

Furthermore, in this embodiment, the values of the nodes 520 of the output layer 510 are determined by applying the Softmax function onto the values of the nodes 518 of the preceding layer 508. By applying the Softmax function, the sum the values of all nodes 520 of the output layer 510 is 1, and all values of all nodes 520 of the output layer are real numbers between 0 and 1.

A convolutional neural network 500 can also comprise a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks can be wired using summation (residual/dense neural networks), element-wise multiplication (attention) or other differentiable operators. Therefore, the convolutional neural network architecture can be nested rather than being sequential if the whole pipeline is differentiable.

In particular, convolutional neural networks 500 can be trained based on the backpropagation algorithm. For preventing overfitting, methods of regularization can be used, e.g. dropout of nodes 512-520, stochastic pooling, use of artificial data, weight decay based on the L1 or the L2 norm, or max norm constraints. Different loss functions can be combined for training the same neural network to reflect the joint training objectives. A subset of the neural network parameters can be excluded from optimization to retain the weights pretrained on another datasets.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIGS. 2 and 3. Certain steps or functions of the methods and workflows described herein, including one or more of the steps or functions of FIGS. 2 and 3, may be performed by a server or by another processor in a network-based cloud-computing system. Certain steps or functions of the methods and workflows described herein, including one or more of the steps of FIGS. 2 and 3, may be performed by a client computer in a network-based cloud computing system. The steps or functions of the methods and workflows described herein, including one or more of the steps of FIGS. 2 and 3, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIGS. 2 and 3, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 602 that may be used to implement systems, apparatus, and methods described herein is depicted in FIG. 6. Computer 602 includes a processor 604 operatively coupled to a data storage device 612 and a memory 610. Processor 604 controls the overall operation of computer 602 by executing computer program instructions that define such operations. The computer program instructions may be stored in data storage device 612, or other computer readable medium, and loaded into memory 610 when execution of the computer program instructions is desired. Thus, the method and workflow steps or functions of FIG. 2 can be defined by the computer program instructions stored in memory 610 and/or data storage device 612 and controlled by processor 604 executing the computer program instructions. For example, the computer program instructions can be implemented as computer executable code programmed by one skilled in the art to perform the method and workflow steps or functions of FIGS. 2 and 3. Accordingly, by executing the computer program instructions, the processor 604 executes the method and workflow steps or functions of FIGS. 2 and 3. Computer 602 may also include one or more network interfaces 606 for communicating with other devices via a network. Computer 602 may also include one or more input/output devices 608 that enable user interaction with computer 602 (e.g., display, keyboard, mouse, speakers, buttons, etc.).

Processor 604 may include both general and special purpose microprocessors, and may be the sole processor or one of multiple processors of computer 602. Processor 604 may include one or more central processing units (CPUs), for example. Processor 604, data storage device 612, and/or memory 610 may include, be supplemented by, or incorporated in, one or more application-specific integrated circuits (ASICs) and/or one or more field programmable gate arrays (FPGAs).

Data storage device 612 and memory 610 each include a tangible non-transitory computer readable storage medium. Data storage device 612, and memory 610, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 608 may include peripherals, such as a printer, scanner, display screen, etc. For example, input/output devices 608 may include a display device such as a cathode ray tube (CRT) or liquid crystal display (LCD) monitor for displaying information to the user, a keyboard, and a pointing device such as a mouse or a trackball by which the user can provide input to computer 602.

An image acquisition device 614 can be connected to the computer 602 to input image data (e.g., medical images) to the computer 602. It is possible to implement the image acquisition device 614 and the computer 602 as one device. It is also possible that the image acquisition device 614 and the computer 602 communicate wirelessly through a network. In a possible embodiment, the computer 602 can be located remotely with respect to the image acquisition device 614.

Any or all of the systems and apparatus discussed herein may be implemented using one or more computers such as computer 602.

One skilled in the art will recognize that an implementation of an actual computer or computer system may have other structures and may contain other components as well, and that FIG. 6 is a high-level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving a trigger for automatically training a machine learning based model;
in response to receiving the trigger, automatically invoking a preprocessing manager for executing preprocessing code for preprocessing training data;
automatically invoking a training manager for executing training code for training the machine learning based model based on the preprocessed training data;
automatically invoking a deployment manager for executing deployment code for converting the trained machine learning based model to a production model; and
outputting the production model.

2. The method of claim 1, wherein receiving a trigger for automatically training a machine learning based model comprises:
receiving the trigger for automatically training a machine learning based model in response to a user request.

3. The method of claim 1, wherein receiving a trigger for automatically training a machine learning based model comprises:
receiving the trigger for automatically training a machine learning based model at a predetermined time.

4. The method of claim 1, wherein the steps of receiving, automatically invoking the preprocessing manager, automatically invoking the training manager, and automatically invoking the deployment manager are performed by a main manager.

5. The method of claim 4, wherein the main manager, the preprocessing manager, the training manager, and the deployment manager are implemented in separate nodes of a computing device.

6. The method of claim 1, wherein:
the preprocessing code is further for generating a preprocessing report comprising database descriptors and statistics for the training data and validation data,
the training code is further for generating a training report comprising a log of training data, and
the deployment code is further for generating a conversion report comprising data comparing performance of the trained machine learning based model and the production model and a performance report comprising an evaluation of the performance of the production model.

7. The method of claim 1, wherein the machine learning based model is a deep learning model.

8. An apparatus comprising:
means for receiving a trigger for automatically training a machine learning based model;
means for automatically invoking a preprocessing manager for executing preprocessing code for preprocessing training data in response to receiving the trigger;
means for automatically invoking a training manager for executing training code for training the machine learning based model based on the preprocessed training data;
means for automatically invoking a deployment manager for executing deployment code for converting the trained machine learning based model to a production model; and
means for outputting the production model.

9. The apparatus of claim 8, wherein the means for receiving a trigger for automatically training a machine learning based model comprises:
means for receiving the trigger for automatically training a machine learning based model in response to a user request.

10. The apparatus of claim 8, wherein the means for receiving a trigger for automatically training a machine learning based model comprises:
means for receiving the trigger for automatically training a machine learning based model at a predetermined time.

11. The apparatus of claim 8, wherein the means for receiving, the means for automatically invoking the preprocessing manager, the means for automatically invoking the training manager, and the means for automatically invoking the deployment manager are performed by a main manager.

12. The apparatus of claim 11, wherein the main manager, the preprocessing manager, the training manager, and the deployment manager are implemented in separate nodes of a computing device.

13. The apparatus of claim 8, wherein:
the preprocessing code is further for generating a preprocessing report comprising database descriptors and statistics for the training data and validation data,
the training code is further for generating a training report comprising a log of training data, and the deployment code is further for generating a conversion report comprising data
comparing performance of the trained machine learning based model and the production model and a performance report comprising an evaluation of the performance of the production model.

14. The apparatus of claim 8, wherein the machine learning based model is a deep learning model.

15. A non-transitory computer readable medium storing computer program instructions, the computer program instructions when executed by a processor cause the processor to perform operations comprising:
receiving a trigger for automatically training a machine learning based model;
in response to receiving the trigger, automatically invoking a preprocessing manager for executing preprocessing code for preprocessing training data;
automatically invoking a training manager for executing training code for training the machine learning based model based on the preprocessed training data;
automatically invoking a deployment manager for executing deployment code for converting the trained machine learning based model to a production model; and
outputting the production model.

16. The non-transitory computer readable medium of claim 15, wherein receiving a trigger for automatically training a machine learning based model comprises:
receiving the trigger for automatically training a machine learning based model in response to a user request.

17. The non-transitory computer readable medium of claim 15, wherein receiving a trigger for automatically training a machine learning based model comprises:
receiving the trigger for automatically training a machine learning based model at a predetermined time.

18. The non-transitory computer readable medium of claim 15, wherein the operations of receiving, automatically invoking the preprocessing manager, automatically invoking the training manager, and automatically invoking the deployment manager are performed by a main manager.

19. The non-transitory computer readable medium of claim 18, wherein the main manager, the preprocessing manager, the training manager, and the deployment manager are implemented in separate nodes of a computing device.

20. The non-transitory computer readable medium of claim 15, wherein:
the preprocessing code is further for generating a preprocessing report comprising database descriptors and statistics for the training data and validation data,
the training code is further for generating a training report comprising a log of training data, and
the deployment code is further for generating a conversion report comprising data comparing performance of the trained machine learning based model and the production model and a performance report comprising an evaluation of the performance of the production model.
